(19) United States
(12) Patent Application Publication
(10) Pub. No.: US 2005/0033518 A1
(43) Pub. Date: Feb. 10, 2005

(54) Method for wavelet-based seismic amplitude inversion

(76) Inventor: Edward Louis Jenner, Lakewood, CO (US)

Correspondence Address: Charles Schweppe, L.C., 8114 Landau Park Lane, Spring, TX, 77379-7169, US

(21) Appl. No.: 10/636,018

(22) Filed: Aug. 7, 2003

(51) Int. Cl. G01V 1/00

(52) U.S. Cl. 702/14

(57) ABSTRACT

A seismic data set comprising a plurality of time samples is selected for wavelet-based seismic amplitude inversion. A plurality of time windows in the seismic data set are selected. A reflectivity is determined for each time window, using the time samples within the time window.

### BACKGROUND OF THE INVENTION

1. Field of the Invention

This invention relates generally to the field of geophysical prospecting. More particularly, the invention relates to the field of seismic data processing. Specifically, the invention is a method for wavelet-based seismic amplitude inversion.

2. Description of the Related Art

Seismic prospecting begins by artificially inducing a seismic surface disturbance in the earth using explosives, air guns, or mechanical vibrators. The resulting seismic waves propagate into the earth and are partially reflected back toward the surface by the interfaces between geological layers. A reflecting interface is the boundary between two layers with differing lithological properties such that part of the energy in the seismic wave is reflected. The reflected waves are then sensed and recorded by detectors on the surface at some measured distance from the seismic wave source. The portion of the wave that is reflected is determined by the reflection coefficient of each geological interface, which depends upon the variance in the lithological characteristics between the upper and lower layers adjacent to each interface.

The detected geological layers are studied for shapes of a composition and structure (such as stratigraphic traps of porous sandstone) conducive to hydrocarbon reservoir accumulation. A reservoir is rock with a sufficient content of interconnected pore space to deliver commercial quantities of hydrocarbons to a producing well. However, the actual composition of the geological layers is not revealed, only their shape. Under certain narrow conditions, a natural gas charged reservoir may have a high seismic wave reflection coefficient at the top interface between the gas and the cap layer. This may be indicated by an anomalously high reflected wave amplitude, called a “bright spot” on a seismic section. The interface between gas and water at the lower extreme of the gas accumulation may produce another seismic wave reflection anomaly, called a “flat spot”. Seismologists have attempted to use bright spots and flat spots as hydrocarbon indicators, at least for gas.

It has been observed that the seismic reflection amplitude of a given interface varies depending upon the distance between the seismic disturbance source and detector. The horizontal distance between the source and the detector is the offset. This variance has been used to help determine hydrocarbon accumulations. The recorded amplitudes are converted into estimates of lithological parameters such as Poisson's ratio, material density, and seismic wave velocity for geological strata within the ground. These parameter estimates can then be compared to known parameters of known strata in order to predict such reservoir properties as the lithologic type, porosity, and the pore fluid or gas content of the unknown strata. The pore fluids characterized could include injected fluids, such as carbon dioxide or nitrogen, as well as hydrocarbons.

The dependence of seismic reflection amplitude upon the offset between source and receiver has been intensely investigated. The Zoeppritz equations give the reflection and transmission coefficients for plane waves as a function of the angle of incidence and six independent elastic parameters, three on each side of the reflecting surface. The angle of incidence is the angle between a particular ray and the normal (perpendicular) to a particular interface. The seismic reflection amplitude could also be viewed as varying with azimuth. The azimuth is the angle between the direction of the source-receiver profile line and another predefined direction such as true north or the structural dip direction. The inverse problem is to make inferences about the elastic parameters from observation of the seismic reflection amplitudes as a function of offset or angle.

The seismic reflection amplitude variations may be expressed as functions of offset, angle of incidence, or azimuth angle. This leads to Amplitude Variation with Offset (AVO), Amplitude Variation with incidence Angle (AVA), or Amplitude Variation with Azimuth (AVAZ, or sometimes called AAVO for Azimuthal AVO). In the literature, the modeled reflection amplitudes are usually derived as functions of angle of incidence. However, the observed reflection amplitudes available from field data are usually given as functions of offset. The two expressed forms are equivalent and may be transformed back and forth as convenient.

Simplifications of the Zoeppritz equations provide explorationalists with a theoretical framework for using seismic amplitude variations with horizontal distance to explore for hydrocarbons. An early simplification is found in Bortfeld, R., “Approximation to the reflection and transmission coefficients of plane longitudinal and transverse waves”, Geophysical Prospecting, Vol. 9, 1961, pp. 485-502. Bortfeld discloses an approximation expression with two terms that have contrasting elastic and acoustic reflection coefficients. The first term (fluid factor) involves only velocity and density.

Aki, K. I., and Richards, P. G., Quantitative Seismology, W.H. Freeman and Co., 1980, p. 153, discloses an approximation for the P-wave reflection amplitude R(θ) that applies for small percentage changes in elastic properties. The approximation is given by a three-term expression in terms of density changes Δρ/ρ, compressional wave (or P-wave) changes ΔVₚ/ₚ, and shear wave (or S-wave) changes ΔVₛ/Vₛ.

One of the most commonly used simplifications is found in Shuey, R. T., “A simplification of the Zoeppritz equations”, Geophysics, Vol. 50, No. 4, April, 1985, pp. 609-614. Shuey discloses a simplification for expressing the compressional wave reflection coefficient R(θ) given by the Zoeppritz equations. The simplification is given as a three-term expression. Shuey eliminates shear wave terms Vₛ and ΔVₛ as used in the Aki-Richards approximation in favor of Poisson's ratio terms σ and Δσ. The first term in Shuey's three-term expression depends upon changes in vₚ and ρ and gives the amplitude at normal incidence (θ=0). The second term depends mostly upon changes in a and characterizes R(θ) at intermediate angles (0<θ<30). The coefficient of the second term is a combination of elastic properties that can be determined by analyzing the offset dependence of event amplitude in conventional reflection data. The third term depends upon changes in vₚ and describes the approach to critical angle. The third term is often ignored, leading to a commonly used two-term approximation.

Shuey's two-term approximation can be expressed in the form:
R(θ)=A+B sin²θ, (1)
where R(θ) is the reflection amplitude as a function of the compressional wave incidence angle θ, A is the compressional wave impedance contrast, also commonly known as the intercept, and B is commonly known as the gradient. Note that A represents the reflection amplitude R(θ) at zero offset or zero angle, that is, for θ=0.

Typically, A and B are inverted independently for each time sample. For instance, in the above example, this reflection amplitude response would be characterized by inverting the amplitudes for A and B. The conventional method of AVA analysis is to invert the seismic amplitudes as functions of offset or incidence angles at each time sample after appropriate preprocessing steps. The inversion commonly uses a least squares fitting routine to an approximation to the exact reflectivity. A non-linear inversion could also be used, employing either the exact reflectivity equation or a non-linear approximation.

However, using independent time samples for each reflectivity calculation can lead to problems in the presence of noise, anomalous responses, or small zero-offset reflectivities. Thus, a need exists for a robust method for determining seismic amplitude variation with offset, angle of incidence, or azimuth angle. A need exists for a robust method of seismic amplitude inversion that is not limited to independent inversion at each time sample.

### BRIEF SUMMARY OF THE INVENTION

The invention is a method for wavelet-based seismic amplitude inversion. A seismic data set comprising a plurality of time samples is selected. A plurality of time windows in the seismic data set are selected. A reflectivity is determined for each time window, using the time samples within the time window.

### BRIEF DESCRIPTION OF THE DRAWINGS

The invention and its advantages may be more easily understood by reference to the following detailed description and the attached drawings, in which:

FIG. 1 is a flowchart illustrating the processing steps of an embodiment of the method of the invention for seismic amplitude inversion;

FIG. 2 is a flowchart illustrating the initial processing steps common to three implementations of the embodiment of the method of the invention described with reference to the flowchart in FIG. 1;

FIG. 3 is a flowchart illustrating the further processing steps of a first implementation of the embodiment of the method of the invention begun in the flowchart in FIG. 2;

FIG. 4 is a plot of seismic amplitude versus sin²θ illustrating the first implementation described with reference to the flowchart in FIG. 3;

FIG. 5 is a flowchart illustrating the further processing steps of a second implementation of the embodiment of the method of the invention begun in the flowchart in FIG. 2;

FIG. 6 is a plot of seismic amplitude versus sin²θ illustrating the second implementation described with reference to the flowchart in FIG. 5; and

FIG. 7 is a flowchart illustrating the further processing steps of a third implementation of the embodiment of the method of the invention begun in the flowchart in FIG. 2; and

FIG. 8 is a plot of seismic amplitude versus sin²θ illustrating the third implementation described with reference to the flowchart in FIG. 7.

While the invention will be described in connection with its preferred embodiments, it will be understood that the invention is not limited to these. On the contrary, the invention is intended to cover all alternatives, modifications, and equivalents that may be included within the scope of the invention, as defined by the appended claims.

### DETAILED DESCRIPTION OF THE INVENTION

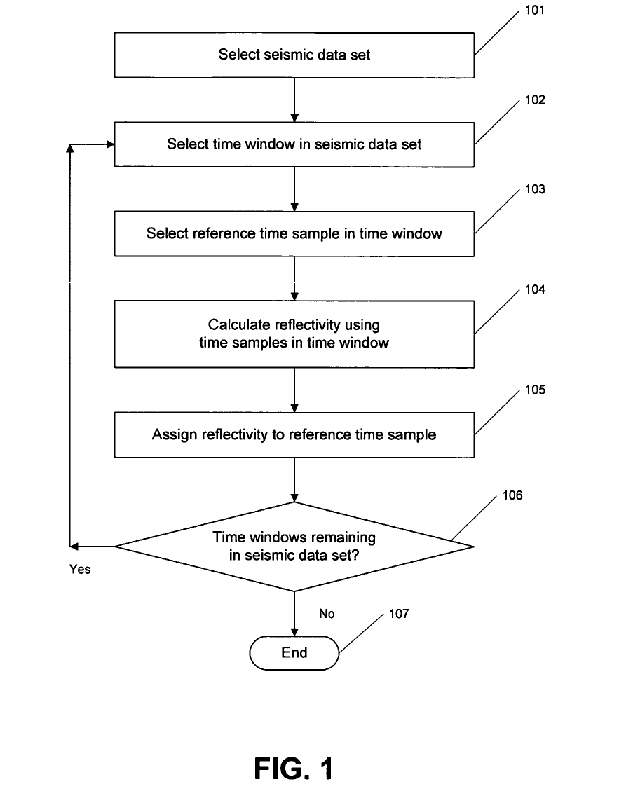

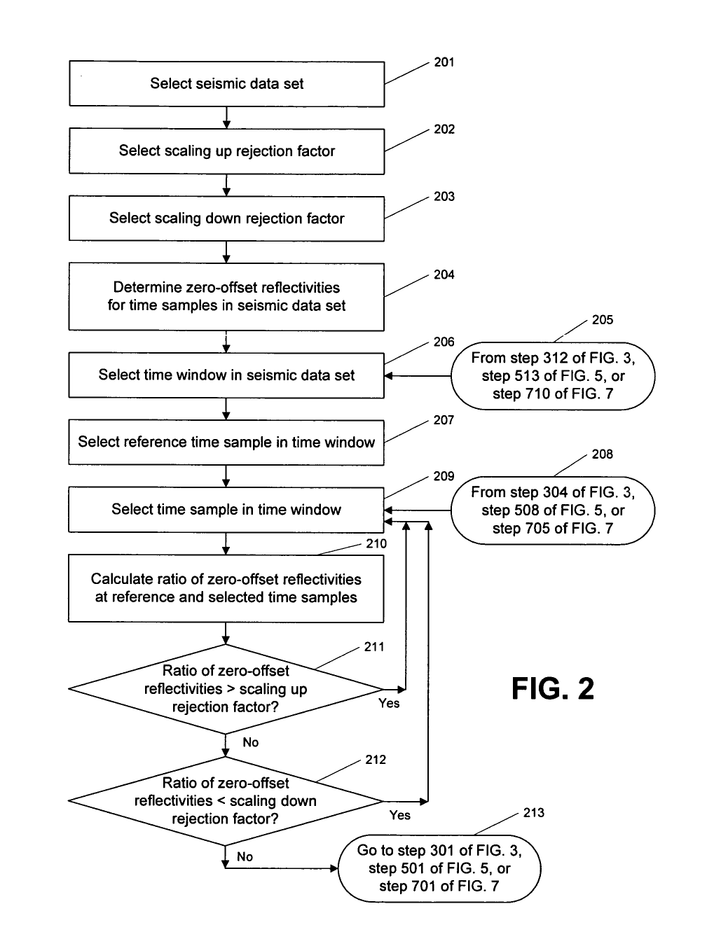

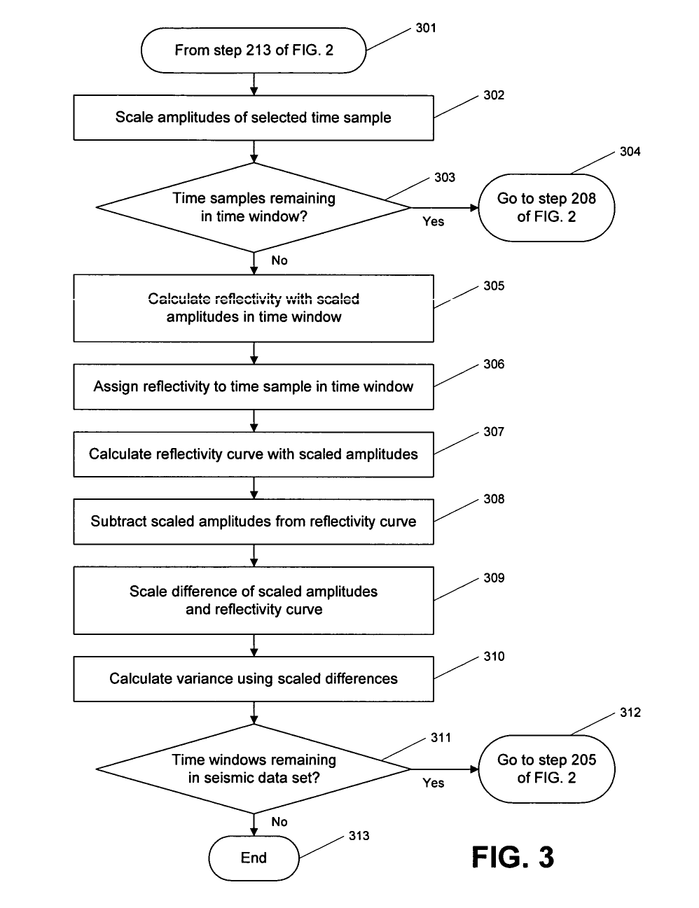

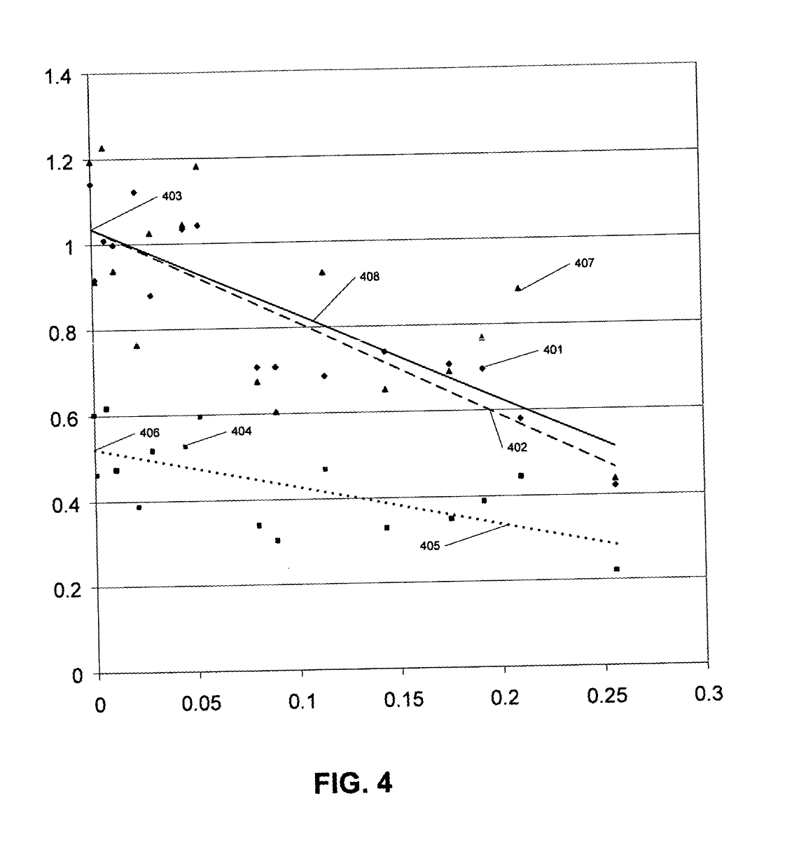

The invention is a method for wavelet-based seismic amplitude inversion. FIG. 1 shows a flowchart illustrating the main processing steps of an embodiment of the method of the invention. The invention will be further demonstrated by describing three particular implementations of the embodiment described with reference to the flowchart in FIG. 1. FIGS. 2, 3, 5, and 7 show the processing steps of the three implementations. FIG. 2 shows a flowchart of the initial processing steps common to all three implementations. Then, FIGS. 3, 5, and 7 show three flowcharts illustrating the further processing steps distinguishing the three particular implementations. FIGS. 4, 6, and 8 show three examples illustrating the three implementations described with reference to the flowcharts in FIGS. 3, 5, and 7, respectively.

FIG. 1 shows a flowchart illustrating the processing steps of an embodiment of the method of the invention for seismic amplitude inversion.

First, at step 101, a seismic data set is selected. The seismic data set comprises a plurality of time samples. Each time sample comprises a single time with a plurality of associated seismic amplitudes. The associated seismic amplitudes correspond to different measures of horizontal distance between the seismic sources and receivers used in the seismic survey that collected the seismic data set. Thus, the measures of varying horizontal distance could include, but not be limited to, measures of offset, angle of incidence, and azimuth angle. The data set is preferably a seismic gather that displays the reflections from the same subsurface location at the same traveltime, usually the zero-offset traveltime. This gather may be obtained through normal moveout correction (NMO) for horizontal layers, but may also be achieved through picking seismic amplitudes along a traveltime path, any non-NMO time shifts, prestack migration or any other method known or unknown at this time.

At step 102, a time window of interest is selected within the seismic data set selected in step 101. The size of the time window is preferably selected to be approximately equal to the dominant period in the seismic data set, measured from one peak to the next peak. The size of the time window is typically 15-35 ms, depending upon the data quality and frequency content of the selected seismic data set. The time window and the time of center of the time window may vary with offset, incidence angle, azimuth, or other parameter. Alternatively, preprocessing, such as a static shift or resampling, may be applied to the seismic data set so that, for instance, the centers of the time windows are all at the same time. The invention is not restricted in the method of obtaining the seismic amplitudes at a subsurface location as a function of offset, incidence angle, azimuth, or any other parameter used in the inversion.

At step 103, a reference time sample is selected within the time window selected in step 102. The reference time sample is preferably selected as the center time sample within the time window. However, the invention is not limited to this selection. The reference time sample can be selected as any time sample within time window, such as the first or last time sample within the time window.

Note that the order of steps 102 and 103 should not be construed as a limitation of the invention. A reference time sample of interest could be selected within the seismic data set first and then a time window of interest could be selected around the selected reference time sample second. Either order of steps 102 and 103 would result in an equivalent selection of both the time window (around the reference time sample) and the reference time sample (within the time window).

At step 104, a reflectivity is calculated using the time samples within the time window selected in step 102. The reflectivity within the time widow is calculated by inverting the seismic amplitudes, preferably as function of offset, incidence angle, or azimuth. The inversion typically uses a least squares fitting routine to an approximation to the exact reflectivity. However, another norm, such as an L1 norm, could be used. Additionally, a non-linear inversion could also be used, employing either the exact reflectivity equation or a non-linear approximation. The invention is not limited to these listed means of calculating the inversion.

At step 105, the reflectivity calculated in step 104 is assigned to the reference time sample selected in step 103.

At step 106, it is determined if any time windows of interest remain within the seismic data set selected in step 101. If the answer is yes, more time windows remain, then the process returns to step 102 to select another time window within the seismic data set and to calculate another reflectivity from the time samples within the newly selected time window. If the answer is no, no more time windows remain, then the process continues to step 107.

At step 107, the processing steps end. In this manner, the present invention, as described with reference to the flowchart in FIG. 1, calculates reflectivities at time samples in the seismic data set using time samples from a surrounding time window.

In the present invention, data within a time window are used to compute the AVA response. This implies that the AVA response at a particular time is dependent upon the seismic amplitudes at earlier and/or later times. The time window is moved down the trace and the AVA response is recomputed for all times of interest in the CDP gather. In this way, the AVA response is computed at every time sample in the data volume. However, it utilizes data within a time window around each time sample.

The invention will be further demonstrated by describing three particular implementations. FIG. 2 shows a flowchart illustrating the initial processing steps common to all three implementations of the embodiment of the method of the invention described with reference to the flowchart in FIG. 1.

First, at step 201, a seismic data set comprising a plurality of time samples is selected. The seismic data set is selected as described in step 101 of FIG. 1, above.

At step 202, a scaling up rejection factor is selected for the seismic data set selected in step 201. This scaling up rejection factor will be used to reject time samples that would have to be scaled up too high.

At step 203, a scaling down rejection factor is selected for the seismic data set selected in step 201. This scaling down rejection factor will be used to reject time samples that would have to be scaled down too low. The scaling down rejection factor may be different from the scaling up rejection factor selected in step 202.

At step 204, a zero-offset reflectivity is determined for each time sample in the seismic data set selected in step 201. The zero-offset reflectivity may be calculated or estimated by any means known in the art. Typically, the zero-offset reflectivity is calculated by inverting the seismic amplitudes as a function of offset, incidence angle, or azimuth, singularly or in combination. However, the invention is not limited to this means of calculation. The calculation may also be accomplished through a near offset stack or a full offset stack, for example. Additional processing of the zero-offset reflectivity, including, but not limited to, noise reduction or other filtering, may also be done.

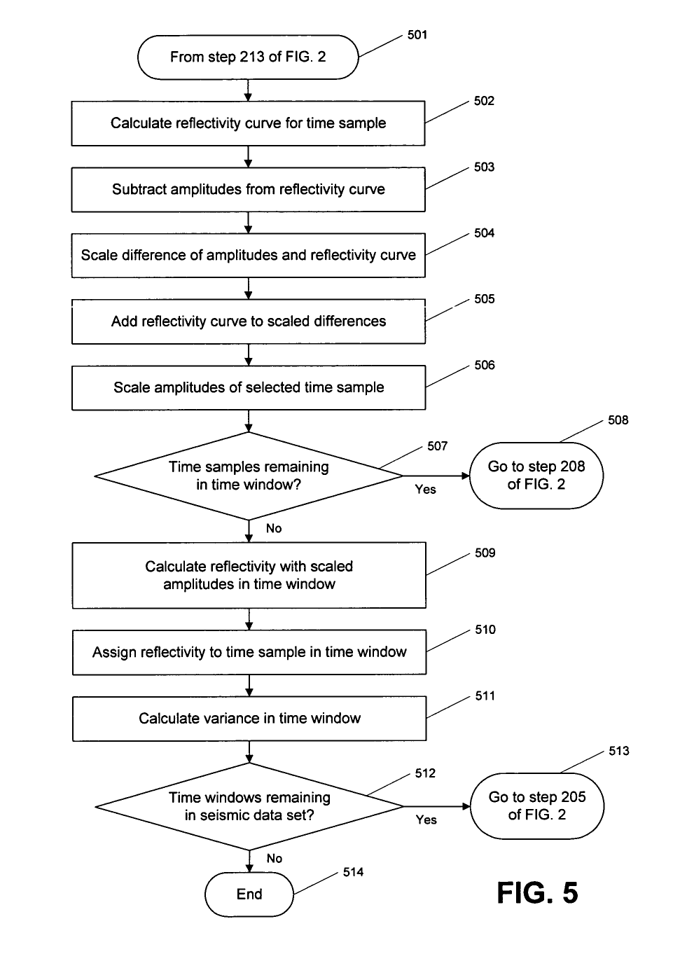

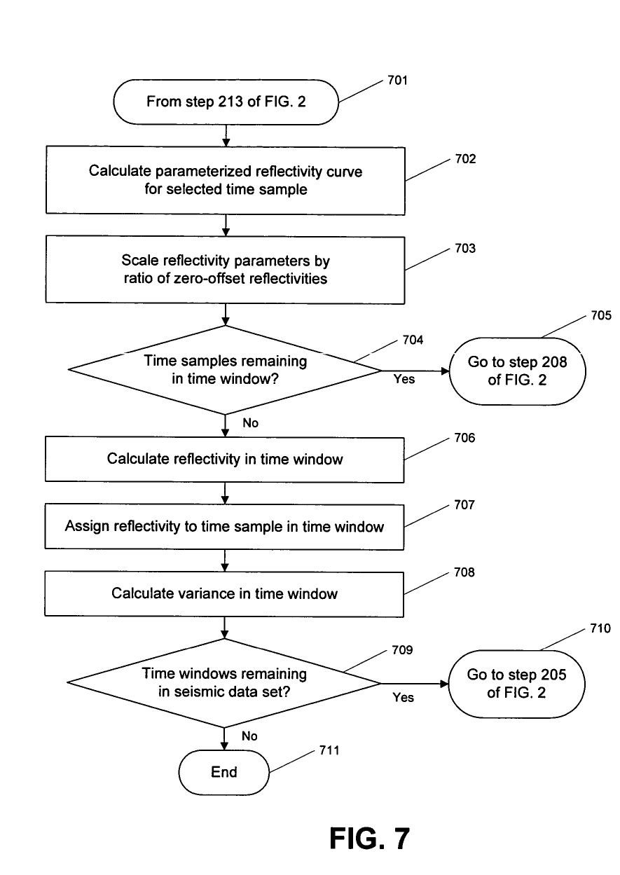

At step 205, the process may loop back from step 312 of FIG. 3, step 513 of FIG. 5, or step 710 of FIG. 7. The process then continues to step 206.

At step 206, a time window of interest is selected within the seismic data set selected in step 201. The time window is selected as described in step 102 of FIG. 1, above.

At step 207, a reference time sample is selected within the time window selected in step 206. The reference time sample is selected as described in step 103 of FIG. 1, above.

At step 208, the process may loop back from step 304 of FIG. 3, step 508 of FIG. 5, or step 705 of FIG. 7. The process then continues to step 209.

At step 209, a time sample is selected within the time window selected in step 206. Each of the time samples within the time window will be selected in turn. The order of selection is not a limitation of the invention. However, for computational ease and efficiency, the selection could be done in a systematic manner. For example, the time samples could be selected in order of ascending or descending time value within the time window, starting with the lowest or highest time value, respectively.

At step 210, a ratio of the zero-offset reflectivity of the reference time sample selected in step 207 to the zero-offset reflectivity of the time sample selected in step 209 is calculated from the zero-offset reflectivities determined in step 204.

At step 211, the ratio of zero-offset reflectivities calculated in step 210 is compared to the scaling up rejection factor selected in step 202. If the calculated ratio is greater than the scaling up rejection factor, the process returns to step 209 to select another time sample within the time window. The rejection of time samples that have a ratio of zero-offset reflectivities greater than the scaling up rejection factor avoids scaling up noise in the seismic data.

At step 212, the ratio of zero-offset reflectivities calculated in step 210 is compared to the scaling down rejection factor selected in step 203. If the calculated ratio is less than the scaling down rejection factor, the process returns to step 209 to select another time sample within the time window. The rejection of time samples that have a ratio of zero-offset reflectivities less than the scaling down rejection factor avoids scaling up noise in the seismic data.

At step 213, the process continues to step 301 of FIG. 3 for the first implementation, to step 401 of FIG. 4 for the second implementation, or to step 501 of FIG. 5 for the third implementation.

The first of the three implementations will be described with reference to FIG. 3. FIG. 3 shows a flowchart illustrating the further processing steps of a first implementation of the embodiment of the method of the invention begun in the flowchart in FIG. 2.

At step 301, the process continues from step 213 of FIG. 2. The process proceeds with the first implementation of the embodiment of the invention.

At step 302, the seismic amplitudes in the time sample selected in step 209 of FIG. 2 are scaled. The seismic amplitudes are scaled by multiplication by the corresponding ratio of zero-offset reflectivities calculated in step 210 of FIG. 2.

At step 303, it is determined if any time samples of interest remain within the time window selected in step 206 of FIG. 2. If the answer is yes, more time samples remain, then the process goes to step 304 to return to select another time sample. If the answer is no, no more time samples remain, then the process continues to step 305.

At step 304, the process returns to step 207 of FIG. 2 to select another time sample within the time window and to scale the seismic amplitudes in this newly selected time sample.

At step 305, a reflectivity is calculated by inverting the scaled seismic amplitudes in the time samples from step 302 within the time window selected in step 206. The inversion may be performed by any means known in the art, as described in step 104 of FIG. 1. The reflectivity is preferably computed by inverting the scaled seismic amplitudes from step 302 as a function of offset, incidence angle, or azimuth. This yields a fitted reflectivity curve that can be used in the calculation of a variance, starting in step 306.

At step 306, the reflectivity calculated in step 305 is assigned to a time sample within the time window selected in step 206 of FIG. 2. The reflectivity is preferably assigned to the reference time sample selected in step 207 of FIG. 2. However, the reflectivity may be assigned to any time sample within the time window.

At step 307, a reflectivity curve is fitted to the scaled seismic amplitudes in the time samples from step 302. If the calculation of reflectivity in step 305 yielded a fitted reflectivity curve, then the calculation need not be repeated. Otherwise, the fitted reflectivity curve is preferably computed by inverting the scaled seismic amplitudes from step 302 as a function of offset, incidence angle, or azimuth.

At step 308, the scaled seismic amplitudes from step 302 are subtracted from the corresponding values in the fitted reflectivity curve calculated in either step 305 or 307.

At step 309, each difference between scaled seismic amplitudes and the fitted reflectivity curve, calculated in step 308, is scaled. Each difference is scaled by division by the corresponding ratio of zero-offset reflectivities calculated in step 210 of FIG. 2. This scaling of the differences yields scaled deviations of the scaled seismic amplitudes.

At step 310, a variance is calculated for all time samples within the time window using the scaled deviations calculated in step 309. The variance may be used for error analysis.

At step 311, it is determined if any time windows of interest remain within the seismic data set selected in step 201 of FIG. 2. If the answer is yes, more time windows remain, then the process goes to step 312 to select another time window. If the answer is no, no more time windows remain, then the process continues to step 313.

At step 312, the process returns to step 205 of FIG. 2 to select another time window within the seismic data set and to calculate another reflectivity from the time samples within the newly selected time window.

At step 313, the processing steps for the first implementation end.

FIG. 4 shows a plot of seismic amplitude versus sin²θ illustrating the first implementation described with reference to the flowchart in FIG. 3. For clarity, the example is shown with the data points from just two time samples in one time window. Typically, many time samples would be used for each time window. The two-term Shuey approximation of Equation (1) is being used with a least squares fit in the inversion to calculate fitted reflectivity curves in this example.

The diamond-shaped data points 401 in FIG. 4 represent the seismic amplitudes plotted against sin²θ, where θ is the incidence angle, obtained from the seismic data of the reference time sample for the time window. The dashed line 402 represents the fitted reflectivity curve for the seismic amplitudes 401 for the reference time sample. The intercept 403 of the fitted reflectivity curve 402 for the reference time sample, the seismic amplitude for sin²θ =0, is the basis for the zero-offset reflectivity for the reference time sample, as calculated in step 204 of FIG. 2.

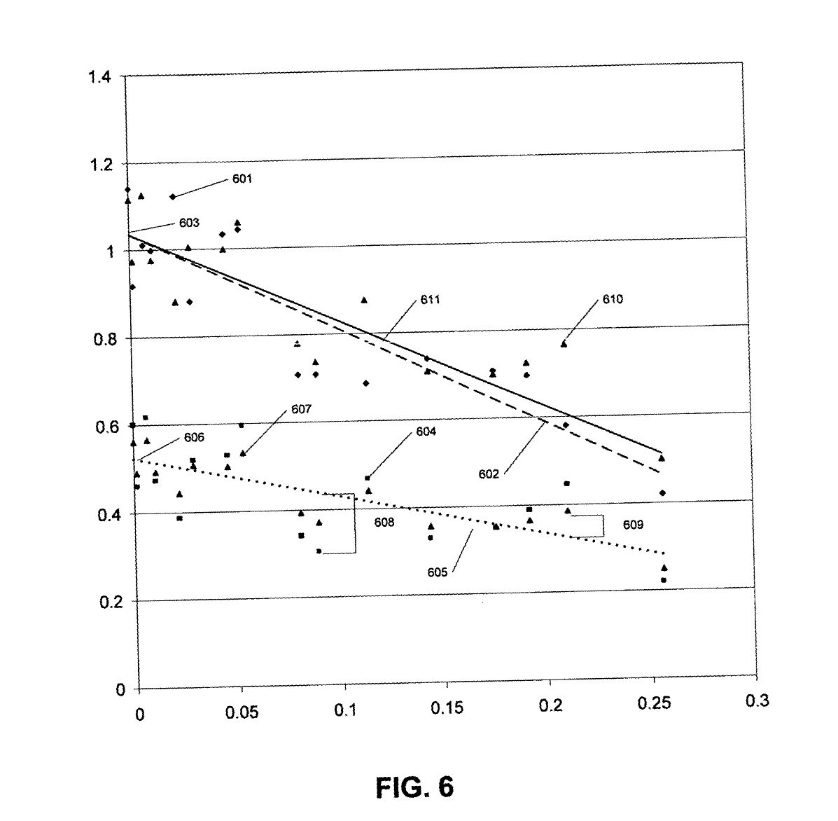

The square-shaped data points 404 in FIG. 6 represent the seismic amplitudes from the seismic data for another time sample in the time window. The dotted line 405 represents the fitted reflectivity curve for the seismic amplitudes 404 for the non-reference time sample. The intercept 406 of the fitted reflectivity curve 405 for the non-reference time sample is the basis for the zero-offset reflectivity for the non-reference time sample, as calculated in step 204 of FIG. 2.

The triangle-shaped data points 407 in FIG. 4 represent the scaled amplitudes calculated in step 302 of FIG. 3. The scaled amplitudes 407 are calculated by multiplying the seismic amplitudes 401 by the corresponding ratio of zero-offset reflectivities (given by the intercepts 403 and 406) calculated in step 210 of FIG. 2. The solid line 408 represents the fitted reflectivity curve for all the time samples in the time window, as calculated in step 305 of FIG. 3.

The second of the three implementations will be described with reference to FIG. 5. FIG. 5 shows a flowchart illustrating the further processing steps of a second implementation of the embodiment of the method of the invention begun in the flowchart in FIG. 2.

At step 501, the process continues from step 213 of FIG. 2. The process proceeds with the second implementation of the embodiment of the invention.

At step 502, a fitted curve is calculated independently for the time sample selected in step 209 of FIG. 2. The fitted curve is preferably calculated to fit the seismic amplitudes to a function of offset, incidence angle, or azimuth.

At step 503, a difference is calculated for each seismic amplitude in the time sample. The difference is calculated by subtraction of each seismic amplitude in the time sample from the corresponding value on the fitted curve calculated in step 502.

At step 504, the difference between the seismic amplitudes and fitted curve, calculated in step 503, is scaled. The difference is scaled by division by the corresponding ratio of zero-offset reflectivities calculated in step 210 of FIG. 2.

At step 505, the seismic amplitudes in the time sample selected in step 209 of FIG. 2 are recalculated. The seismic amplitudes are recalculated by addition of the fitted curve calculated in step 502 to the scaled difference calculated in step 504. The result of implementing steps 504 and 505 is to scale the seismic amplitudes in the time sample such that the differences between the seismic amplitudes and the fitted curve are scaled by the inverse of the ratio of zero offset reflectivities calculated in step 210.

At step 506, the recalculated seismic amplitudes from step 505 are scaled. The recalculated seismic amplitudes are scaled by multiplication by the corresponding ratio of zero-offset reflectivities calculated in step 210 of FIG. 2.

At step 507, it is determined if any time samples of interest remain within the time window selected in step 206 of FIG. 2. If the answer is yes, more time samples remain, then the process goes to step 508 to return to select another time sample. If the answer is no, no more time samples remain, then the process continues to step 509.

At step 508, the process returns to step 208 of FIG. 2 to select another time sample within the time window and to scale the seismic amplitudes at this newly selected time sample.

At step 509, a reflectivity is calculated for the time samples within the time window selected in step 206 of FIG. 2. The reflectivity is preferably calculated by inverting the rescaled seismic amplitudes from step 506 as a function of offset, incidence angle, or azimuth.

At step 510, the reflectivity calculated in step 509 is assigned to a time sample in the time window selected in step 206 of FIG. 2. The reflectivity is preferably assigned to the reference time sample selected in step 207 of FIG. 2. However, the reflectivity may be assigned to any time sample in the time window.

At step 511, a variance is calculated for the time samples within the time window.

At step 512, it is determined if any time windows of interest remain within the seismic data set selected in step 201 of FIG. 2. If the answer is yes, more time windows remain, then the process goes to step 513 to return to select another time window. If the answer is no, no more time windows remain, then the process continues to step 514.

At step 513, the process returns to step 205 of FIG. 2 to select another time window within the seismic data set and to calculate another reflectivity from the time samples within the newly selected time window.

At step 514, the processing steps for the second implementation end. If the fitted curve calculated in step 502 was used to calculate the zero-offset reflectivities in step 204 of FIG. 2, and a linear least squares fit was used, then the results from implementation 2, as described with reference to FIG. 5, should match the results from implementation 1, as described with reference to FIG. 3, above.

FIG. 6 shows a plot of seismic amplitude versus sin²θ illustrating the second implementation described with reference to the flowchart in FIG. 5. Again, for clarity, the example is shown with the data points from just two time samples in one time window. Typically, many time samples would be used for each time window. The two-term Shuey approximation of Equation (1) is being used with a least squares fit in the inversion to calculate fitted reflectivity curves in this example.

The diamond-shaped data points 601 in FIG. 6 represent the seismic amplitudes plotted against sin²θ obtained from the seismic data of the reference time sample for the time window. The dashed line 602 represents the fitted reflectivity curve for the seismic amplitudes 601 for the reference time sample. The intercept 603 of the fitted reflectivity curve 602 for the reference time sample is the basis for the zero-offset reflectivity for the reference time sample, as calculated in step 204 of FIG. 2.

The square-shaped data points 604 in FIG. 6 represent the seismic amplitudes from the seismic data for another time sample in the time window. The dotted line 605 represents the fitted reflectivity curve for the seismic amplitudes 604 for the non-reference time sample. The intercept 606 of the fitted reflectivity curve 605 for the non-reference time sample is the basis for the zero-offset reflectivity for the non-reference time sample, as calculated in step 204 of FIG. 2.

The lower triangle-shaped data points 607 in FIG. 6 represent the scaled seismic amplitudes calculated in step 505 of FIG. 5. The scaled seismic amplitudes 607 are calculated by first subtracting the seismic amplitudes 604 for the non-reference time sample from the fitted reflectivity curve 605 for the non-reference time sample in step 503. Then, in step 504, the differences 608 are divided by the corresponding ratio of zero-offset reflectivities (given by the intercepts 603 and 606) calculated in step 210 of FIG. 2. Finally, the scaled differences 609 are added to the fitted reflectivity curve 605 for the non-reference time sample in step 505.

The upper triangle-shaped data points 610 in FIG. 6 represent the scaled seismic amplitudes calculated in step 506 of FIG. 5. The scaled seismic amplitudes 610 are calculated by multiplying the recalculated seismic amplitudes 607 by the corresponding ratio of zero-offset reflectivities. The solid line 611 represents the fitted reflectivity curve for all the time samples in the time window, as calculated in step 508 of FIG. 5.

The third of the three implementations will be described with reference to FIG. 7. FIG. 7 shows a flowchart illustrating the further processing steps of a third implementation of the embodiment of the method of the invention begun in the flowchart in FIG. 2.

At step 701, the process continues from step 213 of FIG. 2. The process proceeds with the third implementation of the embodiment of the invention.

At step 702, a parameterized reflectivity curve is calculated for the time sample selected in step 209 of FIG. 2. The parameterized reflectivity curve is preferably calculated by inverting the non-scaled seismic amplitudes as a function of offset, incidence angle, or azimuth. This inversion yields reflectivity parameters for the parameterized reflectivity curve for the time sample.

At step 703, the reflectivity parameters calculated in step 702 are scaled by the corresponding ratio of zero-offset reflectivities for the selected time sample calculated in step 210 of FIG. 2.

At step 704, it is determined if any time samples of interest remain within the time window selected in step 206 of FIG. 2. If the answer is yes, more time samples remain, then the process goes to step 705 to return to select another time sample. If the answer is no, no more time samples remain, then the process continues to step 706.

At step 705, the process returns to step 208 of FIG. 2 to select another time sample within the time window and to calculate the scaled reflectivity parameters in this newly selected time sample.

At step 706, a reflectivity is calculated for the time samples within the time window by inverting a subset of points on the reflectivity curves from each time sample, as calculated in step 702 and scaled in step 703. The reflectivity may be calculated by any means known in the art, as described in step 104 of FIG. 1. Note that least squares inversion is equivalent to simply averaging the parameters computed in step 703 for each time sample selected in step 209.

At step 707, the reflectivity calculated in step 706 is assigned to a time sample in the time window selected in step 206 of FIG. 2. The reflectivity is preferably assigned to the reference time sample selected in step 207 of FIG. 2. However, the reflectivity may be assigned to any time sample in the time window.

At step 708, a variance is calculated for the time samples within the time window.

At step 709, it is determined if any time windows of interest remain within the seismic data set selected in step 201 of FIG. 2. If the answer is yes, more time windows remain, then the process goes to step 710 to return to select another time window. If the answer is no, no more time windows remain, then the process continues to step 711.

At step 710, the process returns to step 205 of FIG. 2 to select another time window within the seismic data set and to calculate another reflectivity from the time samples within the newly selected time window.

At step 711, the processing steps for the third implementation end. If all the time samples in any single time window have exactly the same number of data points and ranges of incidence angle, and if a least squares fit is used in step 706 to calculate reflectivity, then the results from implementation 3, as described with reference to FIG. 7, should match the results from implementation 1, as described with reference to FIG. 3, and implementation 2, as described with reference to FIG. 5.

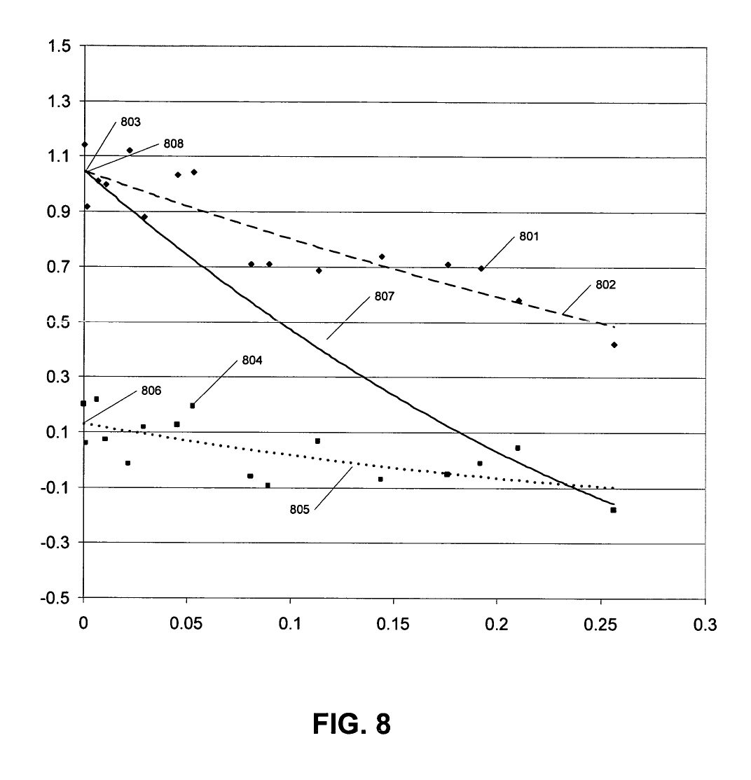

FIG. 8 shows a plot of seismic amplitude versus sin²θ illustrating the third implementation described with reference to the flowchart in FIG. 7. Again, for clarity, the example is shown with the data points from just two time samples in one time window. Typically, many time samples would be used for each time window. In this example, a three-parameter fitted curve (a 2^{nd} order polynomial) is being used with a linear least squares fit in the inversion to calculate fitted reflectivity curves.

The diamond-shaped data points 801 in FIG. 8 represent the seismic amplitudes plotted against sin²θ obtained from the seismic data of the reference time sample for the time window. The dashed curve 802 represents the fitted three-parameter reflectivity curve for the seismic amplitudes 801 for the reference time sample. The fitted reflectivity curve 802 for the reference time sample is given by the expression
y=1.6173 x²−2.6037 x+1.0461, (2)
where y is the seismic amplitude and x is sin²θ. The intercept 803 of the fitted reflectivity curve 802 for the reference time sample is the basis for the zero-offset reflectivity for the reference time sample, as calculated in step 204 of FIG. 2.

The square-shaped data points 804 in FIG. 8 represent the seismic amplitudes from the seismic data for another time sample in the time window. The dotted curve 805 represents the fitted three-parameter reflectivity curve for the non-scaled seismic amplitudes 804 for the non-reference time sample, as calculated in step 702 of FIG. 7. The fitted reflectivity curve 805 for the non-reference time sample is given by the expression
y=1.4668 x²−1.2695 x+0.1296. (3)
The intercept 806 of the fitted reflectivity curve 805 for the non-reference time sample is the basis for the zero-offset reflectivity for the non-reference time sample, as calculated in step 204 of FIG. 2.

Since a linear least squares routine is used for the inversion, the reflectivity parameters can simply be averaged. First, the reflectivity parameters for the fitted reflectivity curve 805 for the non-reference time sample are scaled by the ratio of zero-offset reflectivities. These zero-offset reflectivities are given by the intercept 803 of the fitted reflectivity curve 802 for the reference time sample and the intercept 806 for the fitted reflectivity curve 805 for the non-reference time sample. From Equations (2) and (3), the ratio of zero-offset reflectivities is 1.0461/0.1296=8.0718, as calculated in step 703 of FIG. 7. Note that if the scaling up rejection factor selected in step 202 of FIG. 2 were less than this ratio of zero-offset reflectivities, then this time sample would be rejected in step 211 of FIG. 2. The parameters of the fitted reflectivity curve 805 for the non-reference time sample, given by Equation (3), are multiplied by the ratio of zero-offset reflectivities, as calculated in step 703 of FIG. 7, yielding the scaled reflectivity curve:
y=11.8397 x²−10.2471 x+1.0461. (4)
The parameters of the scaled reflectivity curve, given by Equation (4), are averaged with the parameters of all the other scaled reflectivity curves for the time window. In this example, that is only Equation (2). The result is a reflectivity curve 807 for all the time samples in the time window, given by the expression:
y=6.7287 x²−6.4254 x+1.0463. (4)

The intercept 808 of the fitted reflectivity curve 807 for all the time samples in the time window represents the zero-offset reflectivity for all the time samples. This intercept 808 of the fitted reflectivity curve 807 for all time samples will be the same as the intercept 803 of the fitted reflectivity curve 802 for the reference time sample, which represents the zero-offset reflectivity that all the time samples were scaled to.

The benefits of using the time-windowed approach of the present invention over using independent time samples for each reflectivity calculation, include, but are not limited to, the following. The present invention attenuates the influence of NMO stretch and of seismic waveform tuning. The present invention increases robustness where noise is present and where the zero-offset reflectivity is small. The present invention increases the separation of an anomalous response from the background trend.

It should be understood that the preceding is merely a detailed description of specific embodiments of this invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents.

1. A method for wavelet-based seismic amplitude inversion, comprising:
selecting a seismic data set comprising a plurality of time samples;
selecting a plurality of time windows in the seismic data set; and
determining a reflectivity for each time window, using time samples within the time window.

2. The method of claim 1, wherein the step of selecting a plurality of time windows comprises:
selecting a plurality of time samples in the seismic data set; and
selecting a time window in the seismic data set around each time sample.

3. The method of claim 1, wherein the step of determining a reflectivity comprises:
selecting a reference time sample in the time window; and
determining a reflectivity for the reference time sample, using time samples within the time window.

4. The method of claim 3, wherein the step of determining a reflectivity comprises:
determining zero-offset reflectivities at all time samples in the time window;
selecting a sequence of time samples in the time window;
performing the following steps for each of the sequence of time samples:
calculating a ratio of zero-offset reflectivities at the reference time sample and the selected time sample; and
scaling the selected time sample by the ratio of zero-offset reflectivities; and
calculating a reflectivity for the time window, using the scaled time samples.

5. The method of claim 4, further comprising:
selecting a scaling up rejection factor;
selecting a scaling down rejection factor;
rejecting time samples that have a ratio of zero-offset reflectivities greater than the scaling up rejection factor; and
rejecting time samples that have a ratio of zero-offset reflectivities less than the scaling down rejection factor.

6. The method of claim 4, further comprising:
calculating a variance for the time window, using the scaled time samples.

7. The method of claim 3, wherein the step of determining a reflectivity comprises:
determining zero-offset reflectivities at all time samples in the time window;
selecting a sequence of time samples in the time window;
performing the following steps for each of the sequence of time samples:
calculating a ratio of zero-offset reflectivities at the reference time sample and the selected time sample; and
calculating a reflectivity curve for the time sample; and
scaling the time sample to the reflectivity curve by the ratio of zero-offset reflectivities; and
calculating a reflectivity for the time window, using the scaled time samples.

8. The method of claim 7, further comprising:
selecting a scaling up rejection factor;
selecting a scaling down rejection factor;
rejecting time samples that have a ratio of zero-offset reflectivities greater than the scaling up rejection factor; and
rejecting time samples that have a ratio of zero-offset reflectivities less than the scaling down rejection factor.

9. The method of claim 7, further comprising:
calculating a variance for the time window.

10. The method of claim 3, wherein the step of determining a reflectivity comprises:
determining zero-offset reflectivities at all time samples in the time window;
selecting a sequence of time samples in the time window;
performing the following steps for each of the sequence of time samples:
calculating a ratio of zero-offset reflectivities at the reference time sample and the selected time sample; and
calculating a parameterized reflectivity curve for the time sample; and
scaling the reflectivity curve parameters by the ratio of zero-offset reflectivities; and
calculating a reflectivity for the time window, using the scaled parameterized reflectivity curves.

11. The method of claim 10, further comprising:
selecting a scaling up rejection factor;
selecting a scaling down rejection factor;
rejecting time samples that have a ratio of zero-offset reflectivities greater than the scaling up rejection factor; and
rejecting time samples that have a ratio of zero-offset reflectivities less than the scaling down rejection factor.

12. The method of claim 10, further comprising:
calculating a variance for the time window.
